(19) United States
(12) Patent Application Publication
(10) Pub. No.: US 2008/0128210 A1
(43) Pub. Date: Jun. 5, 2008

(54) Internal Combustion Engine Comprising a Lubricant Circuit and a Damping Element

(75) Inventors: Dirk Lieske, Korntal-Muenchingen (DE); Walter Zipp, Frankfurt (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 10/589,889

(22) PCT Filed: Feb. 18, 2005
(86) PCT No.: PCT/EP05/01678

§ 371 Date: May 25, 2007

(30) Foreign Application Priority Data
Feb. 20, 2004 (DE) 10 2004 008 299.5

(51) Int. Cl. F01M 1/04; F16L 55/04

(52) U.S. Cl. 184/6.5; 184/6.21; 123/196 R

(57) ABSTRACT

This invention involves an internal combustion engine for a motor vehicle with a lubricant pump to transport a fluid, almost incompressible lubricant, especially a motor oil, as well as a lubricant guide element (1b) to guide the lubricant to the lubrication points of the internal combustion engine.

In the internal combustion engine of the invention an elastic, flexible dampening element (2b) to accept pressure pulsations in the lubricant is associated with the lubricant guide element (1b). A dampening element (2b), for example, can have a bypass resonator with a calmed lubricant reservoir (4b).

Use, for example, is in passenger motor vehicles.

### BACKGROUND AND SUMMARY OF THE INVENTION

This invention involves an internal combustion engine for a motor vehicle with a lubricant pump to transport a fluid, almost incompressible lubricant, especially a motor oil, as well as a lubricant guide element to guide the lubricant to the lubrication points of the internal combustion engine.

It is an object of the invention to make available an internal combustion engine for a motor vehicle in which pressure pulsations are dampened within a lubricant guide element and sound radiations are effectively reduced.

This object is achieved by an internal combustion engine as claimed. Advantageous variations and further developments of the invention are also claimed.

According to the invention, an elastic, flexible, dampening element to accept pressure pulsations in the lubricant is associated with the lubrication guide element in the internal combustion engine. The dampening element preferably is a component part guiding the lubricant and thus is coupled in the lubrication circuit so that it is in direct contact with the lubricant. Natural or synthetic oils are preferably used as the lubricant. The dampening element manifests a flexibility in the lubrication circuit, which preferably includes a dead water zone, a resonance area, or a flexible wall. Pressure pulsations of the lubricant can be reduced by friction and turbulence or, as the case may be, by specific discharge into the wall.

In one embodiment of the invention, the dampening element manifests an abrupt expansion of the line cross-section, in the manner of a bypass resonator to form a calmed lubricant reservoir. A dead water zone, in which pressure pulsations of the lubricants can be reduced, is formed in the calmed lubricant reservoir. The expansion of the line cross-section can be designed as a Helmholtz resonator, across which specifically determined oscillation frequencies from the lubrication circuit can be sent.

In another embodiment of the invention, the dampening element manifests a flexible membrane to limit the lubricant reservoir and/or the lubricant guide element. The membrane preferably has a higher elasticity than the other lubricant guide components of the internal combustion engine. For that reason, the membrane is preferably constructed of an elastic material or component, and preferably of a lubricant-resistant plastic. Alternatively, the membrane can be constructed as an especially thin-walled component. The membrane can be housed with lubricant on one side and ambient air on the other side or, as the case may be, in a closed storage volume, preferably under pressure of an inert gas.

In another embodiment of the invention, the dampening element has a storage volume to accept a compressible medium, such as a quantity of gas and/or a foam. The storage volume is preferably separate from the lubrication circuit, but is constructed directly adjacent to it. For separation, a flexible membrane is associated with the gas quantity or a largely closed separating layer with the foam, especially in the form of closed pores. The gas quantity or the foam manifests a higher compressibility than the lubricant.

In another embodiment of the invention, the dampening element includes a storage volume to receive a rubber-elastic body. The rubber-elastic body possesses a higher compressibility than the lubricant, and acts as an especially effective damper for the pressure pulsations that appear. The rubber-elastic body is preferably constructed as a pipe guide element through which the lubricant flows.

In another embodiment of the invention, the dampening element has a storage volume to accept a mixture of the lubricant and a compressible medium, such as a quantity of gas. The lubricant and the compressible medium are not separated in the storage volume, and the degree of intermixing is variable. The intermixing can almost be zero, especially with an internal combustion engine that is not operating, so that a horizontal, free surface of the lubricant lies opposite the compressible medium. A suspension or a largely homogeneous mixture of the lubricant and the compressible medium can also be used, however. Another practical, especially advantageous configuration provides expansion of the lubricant with a compressible medium in the form of air, with the degree of expansion preferably set so that the lubricating effect of the lubricant at lubrication locations of the internal combustion machine is not disadvantageously affected.

In another embodiment of the invention, the elasticity of the membrane, the compressible medium, and/or the rubber-elastic body can be changed or adjusted. That is done by way of a change in pressure, temperature, and/or the volume of the membrane, the compressible medium, or the rubber-elastic body. To influence the temperature of the membrane, the compressible medium, or the rubber-elastic body, an electrical resistance heating, for example, can be used.

In another embodiment of the invention, the quantity of the compressible medium accepted in the storage volume can be changed by the addition and/or removal of the compressible medium via an input opening. The elasticity of the dampening element can be adjusted by a change of the compressible medium in the dampening element. The degree of expansion can thus also be influenced in a case involving expansion of the lubricant with the help of the compressible medium.

In another embodiment of the invention, the dampening element is coupled across a line rising in a vertical direction to a lubricant guide element. In this way, a compressible medium, such as a quantity of gas, is blocked in a storage volume inside a dampening element with the help of the lubricant. Air is preferably used as the compressible medium which can be housed in an especially simple manner in the sealed dampening element.

Other characteristics and combinations of characteristics are apparent from the description and the drawings. Concrete embodiments of the invention are depicted in a simplified manner in the drawings and are explained in more detail in the following description.

### BRIEF DESCRIPTION OF THE DRAWINGS

FIG. 1 is a sketch of a lubricant guide element with a first embodiment of a dampening element of the invention;

FIG. 2 is a sketch of a lubricant guide element with a second embodiment of a dampening element of the invention;

FIG. 3 is a sketch of a lubricant guide element with a third embodiment of a dampening element of the invention;

FIG. 4 is a sketch of a lubricant guide element with a fourth embodiment of a dampening element of the invention;

FIG. 5 is a sketch of a lubricant guide element with a fifth embodiment of a dampening element of the invention;

FIG. 6 is a sketch of a lubricant guide element with a sixth embodiment of a dampening element of the invention;

FIG. 7 is a sketch of a lubricant guide element with a seventh embodiment of a dampening element of the invention;

FIG. 8 is a sketch of a lubricant guide element with an eighth embodiment of a dampening element of the invention;

FIG. 9 is a sketch of a lubricant guide element with a ninth embodiment of a dampening element of the invention;

FIG. 10 is a sketch of a lubricant guide element with a tenth embodiment of a dampening element of the invention; and

FIG. 11 is a sketch of a lubricant guide element with an eleventh embodiment of a dampening element of the invention.

### DETAILED DESCRIPTION OF THE INVENTION

An internal combustion engine has, in a known manner, a lubrication circuit in which a lubricant pump moves a fluid lubricant, in particular a natural or synthetic motor oil, from a lubricant storage reservoir to lubrication points or locations of the internal combustion engine and, as the case may be, back to the storage reservoir. In the process, the lubricant flows in general both through several lubrication guide elements and a housing of the internal combustion engine. The lubrication pump is associated with a lubrication guide element in the shape of a suction pipe line through which the lubricant moves from the storage reservoir (e.g., oil pump) to a lubricant pump.

During operation of an internal combustion engine, the lubricant pump is generally also powered across a transmission by a gear of the internal combustion engine. A pulsating movement of the lubricant is caused by operation of the lubricant pump (e.g. geared wheel pump). The resulting pressure pulsations cause a (mostly unwanted) sound production, transmission, and radiation.

To offset the pressure pulsations mentioned, a flexible dampening element associated with a lubrication guide element of the lubrication circuit is provided according to the invention.

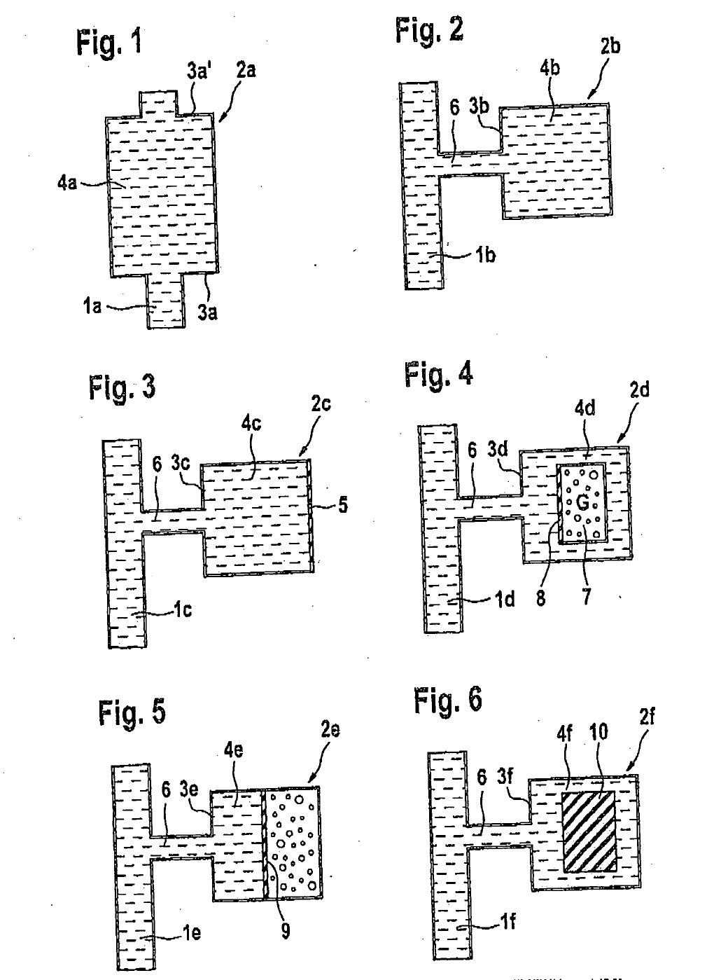

A lubrication guide element 1a is shown in FIG. 1 with a first embodiment of a dampening element 2a of the invention. The lubricant guide element 1a is constructed as an almost vertically positioned suction line of a lubricant pump, which is not shown in more detail. The dampening element 2a thereby manifests an abrupt expansion 3a of the line cross-section of the suction line to form a calmed area 4a. The calmed area includes a certain length of the suction line and ends with an abrupt narrowing 3a′. The dampening element 2a is filled completely with the lubricant, whereby dead water areas that are present form a calmed lubricant reservoir to dampen the pressure pulsations. The lubricant guide element 1a as well as the dampening element 2a can have a round or a non-round, rectangular cross-sectional area, although rectangular cross-sectional areas favor dampening of pressure pulsations in an advantageous manner. This also applies to the other embodiments.

FIG. 2 shows a lubrication guide element 1b with a second embodiment of a dampening element 2b of the invention. The dampening element 2b is constructed as a type of bypass resonator connected with the lubricant guide element 1b across a bleed line 6 (resonator throat) running perpendicular to the lubricant guide element 1b and is completely filled with lubricant. An abrupt expansion 3b of the cross-section of the bleed line 6 is provided to form a calmed lubricant reservoir 4b.

FIG. 3 shows a lubrication guide element 1c with a third embodiment of a dampening element 2c of the invention. There is an abrupt expansion 3c of the cross-section of the bleed line 6 to form a calmed lubricant reservoir 4c. The dampening element according to FIG. 3 differs from the version of FIG. 2 only in that a flexible, elastic membrane 5 forms the wall of the dampening element lying opposite the bleed line 6. In particular, the inside of the membrane 5 is in contact with the lubricant. In the process, it thereby preferably manifests a higher elasticity than most other component elements of the lubricant circuit of the internal combustion engine, so that pressure pulsations can preferably be guided into the membrane area. The dampening element 2c is so positioned that the outside of the membrane is surrounded by ambient air or another compressible medium. In a modified embodiment, the membrane is likewise surrounded on the outside by lubricant, which can be accomplished by housing the dampening element in the lubricant storage reservoir of the internal combustion engine.

FIG. 4 shows a lubrication guide element 1d with a fourth embodiment of a dampening element 2d of the invention. There is an abrupt expansion 3d of the cross-section of the bleed line 6 to form a calmed lubricant reservoir 4d. The dampening element 2d according to FIG. 4 differs from the versions of FIGS. 2 and 3 in that the dampening element 2d has a storage volume 7 that is closed on all sides to accept a defined quantity of gas G. The storage volume 7 has a flexible, elastic membrane 8 and is otherwise constructed with a bowl or pot shape. Pressure pulsations are guided in an advantageous manner specifically across the membrane 8 into the storage volume 7. In a modified embodiment, the storage volume 7 and/or the membrane 8 are constructed so as to be heated by means of electrical resistance heating to adjust the elasticity.

FIG. 5 shows a lubrication guide element 1e with a fifth embodiment of a dampening element 2e of the invention. An abrupt expansion 3e of the cross-section of the bleed line 6 is provided to form a calmed lubricant reservoir 4e. The dampening element 2e according to FIG. 5 differs from that of FIGS. 2 and 3 in that the dampening element 2e has a membrane 9 which divides the lubricant reservoir 4e into two partial volumes preferably of the same size.

FIG. 6 shows a lubrication guide element 1f with a sixth embodiment of a dampening element 2f of the invention. There is an abrupt expansion 3f of the cross-section of the bleed line 6 to form a calmed lubricant reservoir 4f. The dampening element 2f according to FIG. 6 differs from the models of FIGS. 2 and 4 by a storage volume 10 to accept a rubber-elastic shaped body. The shaped body is constructed in a modified execution model to adjust the elasticity by means of electrical resistance heating.

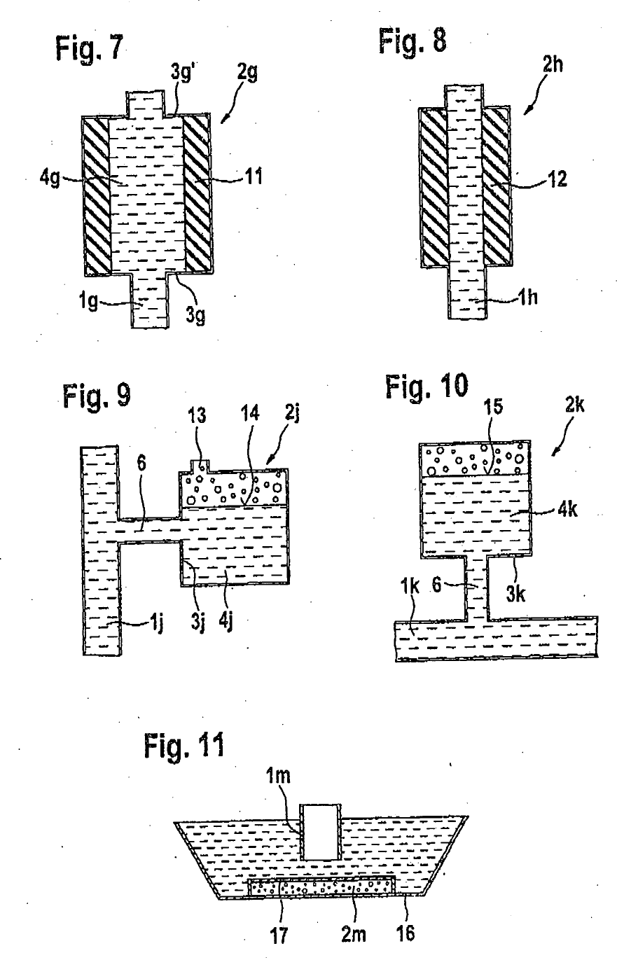

FIG. 7 shows a lubrication guide element 1g with a seventh embodiment of a dampening element 2g of the invention. There is an abrupt expansion 3g of the cross-section of the lubricant guide element 1g to form a calmed area 4g. The calmed area 4g includes a certain long area of a suction line and ends with an abrupt narrowing 3g′. The dampening element 2g is completely filled with lubricant, and the dead water areas present form a calmed lubricant reservoir to dampen the pressure pulsations. Finally a rubber-elastic wall 11 is associated with the dampening element 2g which forms the boundary of the lubricant-guiding interior area. The dampening element 2g is thus designed as a type of normal line element, but compared to the other line elements it manifests an increased compressibility which is designed so that pressure pulsations—especially in the selected frequency ranges—are accepted well and are dampened. The rubber-elastic wall 11 is preferably stiffened with metal on the outside.

FIG. 8 shows a lubrication guide element 1h with an eighth embodiment of a dampening element 2h of the invention. The eighth embodiment differs from the seventh embodiment according to FIG. 7 in that there is no expansion of the cross-section of the lubricant guide element; instead, a lubricant-guiding, rubber-elastic, cylindrical-shaped part 12 is provided. The part 12 is designed in such a compressible manner that pressure pulsations—especially in the selected frequency ranges—are accepted well and are dampened. The rubber-elastic, cylindrical-shaped part 12 is preferably stiffened or encased with metal on the exterior. The length and thickness of the shaped part are selected depending on the frequency range of the pressure pulsations to be dampened. In a modified embodiment, a dampening element according to FIG. 8 substitutes a complete suction line of a lubricant pump.

FIG. 9 shows a lubrication guide element 1j with a ninth embodiment of a dampening element 2j of the invention. The dampening element 2j is constructed like a bypass resonator, and is connected with the lubricant guide element 1j across a bleed line 6 (resonator throat) running perpendicular to the lubricant guide element 1j. An abrupt expansion 3j of the cross-section of the bleed line 6 is provided to form a calmed lubricant reservoir 4j. In addition, a branch boring 13 is positioned on the top of a vertical side of the dampening element 2j. A compressible medium, preferably air, can be introduced to or removed from the lubricant reservoir 4j through the branch boring. Thus, the mass of the air in the reservoir can be varied, by means of the branch boring 13, so that the elasticity of the dampening elements 2j can be adjusted. The lubricant and air are not separated in the lubricant reservoir 4j so that both can mix, and the degree of mixing is variable. The mixing can be almost zero for a non-operating internal combustion engine, i.e., a free, horizontal surface 14 of the lubricant is exposed to the air. A strong expansion of the lubricant with the air can, however, be produced in the area of the lubricant reservoir 4j, so that the entire reservoir 4j can be filled by the expanded mixture of the lubricant and air. The degree of expansion is preferably regulated so that the lubrication effect of the lubricant is not disadvantageously affected at the lubrication lubrications of the internal combustion engine. Thus, an optimal relationship between the dampening effect on the dampening element 2j and the lubrication effect at the lubrication locations of the internal combustion engine can be set by means of the degree of expansion. In addition, an especially high dampening effect against pressure pulsations in the lubricant can be obtained, when needed.

FIG. 10 shows a lubrication guide element 1k with a tenth embodiment of a dampening element 2k of the invention. The dampening element 2k is constructed as a type of bypass resonator, which is connected with the lubricant guide element 1k across a bleed line 6 rising in a vertical direction running perpendicular to a lubricant guide element 1b. There is an abrupt expansion 3k of the cross-section of the bleed line 6 to form a calmed lubricant reservoir 4k. The lubricant reservoir 4k is only partially filled with the lubricant; the other part is filled with a compressible medium, preferably with air or with an inert gas which is confined above the fluid level 15 of the lubricant in the lubricant reservoir 4k and can not be forced out of the reservoir. In a modified embodiment, the reservoir is completely filled, preferably with an inert gas.

FIG. 11 shows a lubrication guide element 1m with an eleventh embodiment of a dampening element 2m of the invention. The dampening element 2m is constructed as a type of gas or air pillow and is placed on the base of the lubricant reservoir which is constructed in the shape of an oil sump 16. In particular, the dampening element 2m is coupled to the lubrication circuit so that it is positioned at a slight distance next to—preferably opposite—the intake suction opening of the lubricant guide element 1m. An elastic membrane 17 is provided on the side of the dampening element 2m facing the intake suction opening.

In all of the embodiments depicted, a coupling of the compressible element (dampening element) to the lubrication circuit of a vehicle internal combustion engine is done in such a way that pressure pulsations are guided into the compressible element and are dampened there or can be guided out of the lubrication circuit. As a result, the sound radiation of the entire internal combustion engine is reduced by way of the invention.

The characteristics of the embodiments of the device of the invention which were described as examples can be combined with each other in any desired manner, so that other advantageous properties and combinations of properties can result.

1-9. (canceled)

10. An internal combustion engine for a motor vehicle with a lubricant pump to transport a fluid, almost incompressible lubricant, comprising:
a lubricant guide element to guide the lubricant to the lubrication points of the internal combustion engine, and
a dampening element associated with the lubricant guide element to accept pressure pulsations in the lubricant,
wherein the dampening element is constructed as a bypass resonator, and
wherein an elastic body is provided in a lubricant reservoir connected with the lubricant guide element across a bleed line.

11. The internal combustion engine according to claim 10, wherein the elastic body is a rubber-elastic, shaped body.

12. The internal combustion engine according to claim 10, wherein the elastic body includes a gas storage volume, adapted to accept a compressible medium, with a side facing the bleed line, and an elastic membrane.

13. The internal combustion engine according to claim 12, wherein the membrane has a changeable or adjustable elasticity.

14. The internal combustion engine according to claim 10, wherein the lubricant is a motor oil.

15. The internal combustion engine according to claim 11, wherein the shaped body has a changeable or adjustable elasticity.

16. An internal combustion engine for a motor vehicle with a lubricant pump to transport a fluid, almost incompressible lubricant, comprising:
a lubricant guide element to guide the lubricant to the lubrication points of the internal combustion engine, and
a dampening element associated with the lubricant guide element to accept pressure pulsations in the lubricant,
wherein the dampening element is constructed as a wall of the lubricant guide element that manifests an increased compressibility.

17. The internal combustion engine according to claim 16, wherein the dampening element is a rubber-elastic, cylindrical shaped part with an interior cross-section corresponding to the interior cross-section of the lubricant guide element.

18. The internal combustion engine according to claim 16, wherein the dampening element includes a calmed area which is formed by an abrupt expansion and an abrupt narrowing of the interior cross-section of the lubricant guide element, and a rubber-elastic wall is associated with the calmed area.

19. The internal combustion engine according to claim 16, wherein the lubricant is a motor oil.

20. An internal combustion engine for a motor vehicle with a lubricant pump to transport a fluid, almost incompressible lubricant, comprising:
a lubricant guide element to guide the lubricant to the lubrication points of the internal combustion engine, and
a dampening element associated with the lubricant guide element to accept pressure pulsations in the lubricant,
wherein the dampening element is positioned in a lubricant reservoir in a vicinity of an intake suction opening of the lubricant guide element.

21. The internal combustion engine according to claim 20, wherein the dampening element is constructed as a gas or air pillow with a side facing the intake suction opening of the lubricant guide element that manifests an elastic membrane.

22. The internal combustion engine according to claim 20, wherein the lubricant is a motor oil.
